(19) United States
(12) Patent Application Publication
(10) Pub. No.: US 2019/0236946 A1
(43) Pub. Date: Aug. 1, 2019

(54) ARRANGEMENT SIGNALLING A VEHICLE USING WARNING DEVICES OR ANY OTHER DANGEROUS VEHICLE OR OBJECT

(71) Applicant: Miklós HAMZA, Kecskemét (HU)

(72) Inventor: Miklós HAMZA, Kecskemét (HU)

(21) Appl. No.: 16/325,090

(22) PCT Filed: Mar. 28, 2017
(86) PCT No.: PCT/HU2017/000024

§ 371 Date: Feb. 12, 2019

(30) Foreign Application Priority Data
May 12, 2016 (HU) U 1600140

(51) Int. Cl. G08G 1/0965; G01S 5/00; G01S 19/42

(52) U.S. Cl. CPC G08G 1/0965; G01S 19/42; G01S 5/0072

(57) ABSTRACT

Layout indicating vehicles or objects using distinctive sign or other dangerous vehicles or objects, which on the one hand contains a priority transmitter fixed to the vehicles or objects using distinctive sign or other dangerous vehicles or objects, on the other hand contains more ordinary units fixed to moving or stationary object. The priority device contains a transmitter operating on a specific audio frequency, and a switch. According to another preferred layout, the priority device is connected to the vehicle's distinctive—sound or light signal device. The ordinary devices contain a radio frequency receiver module, which enables priority devices to establish radio frequency connection with ordinary devices. Furthermore, the system has permanent GPS connection, and a graphic display, a control surface and a speaker are also attached to each receiver unit.

### BACKGROUND OF THE INVENTION

### Field of the Invention

The object of the invention is an equipment increasing the security of vehicles using warning devices or of other dangerous vehicles and of other traffic participants by sending information on the location of the vehicles and objects forming a danger source, or by using any standard offline communication form.

### Description of the Related Art

Application of warning devices had been adopted because it is necessary to assure the priority of vehicles with socially important missions. Thus, such vehicles are exempt of any transport regulations restricting their motion or, in other words, they have priority with respect to other vehicles. The communication of their status is extremely important for the other participants in traffic since they can cause accident dangerous situation due to their higher speed. For the communication of their status, the technical level of our age had introduced the application of strong visual and acoustic effects (siren), however, some other ideas and suggestions of development appeared, too. One of the reasons is that the siren is not always conceivable in acoustically well insulated passenger areas. Such a dangerous situation is caused by opening the vehicle windows only on one side, and the arriving acoustic signal is perceived from a totally different direction. In addition, some other accidents are known, as well, where two vehicles using warning devices could not avoid collision with each other because they were prepared only to the participants in traffic with usual behaviour and speed. Example for one of the suggestions of development is the following patent. In the patent notice entitled “The arrangement compiled from an transceiver-receiver unit for reducing transport accident dangerous situations, as well as for the promotion of the trouble free traffic of vehicles using warning devices” and with number P0800329, which is an transceiver unit equipped with radio aerial (antenna), on the one hand, and a receiver unit having a radio antenna, too. These vehicles are in a radio frequency connection with each other in such a manner that the transceiver unit is installed on the vehicles using the warning device, and the receiver unit in any other vehicle receiving the signals of the vehicle with warning device. The unit of receiver may be connected even to the Hi-fi equipment of the vehicle for suppressing it at the receiver of any transceiver signal. The transceiver unit may be integrated in the safety devices of railways, as well.

In the American patent, Reg. No. U.S. Pat. No. 6,222,461 B1, entitled “Emergency Warning Systems for Vehicles”, a similar system is integrated in locomotives rather than in railway crossings. In the American patent, Reg. No. U.S. Pat. No. 6,087,961 (A) and entitled “Directional Warning System for Detecting Emergency Vehicles”, the unit on the receiver side comprises a direction finder aerial, thus, the receiver unit can loudly read the relative direction of the vehicle using warning device. Another patent, a German one, Reg. No. DE 102010022165 (A1), entitled “Method for detecting acoustic signal of emergency vehicles for another vehicles for police service, involves classifying detected optical signal, and spending warning signal to driver with detected acoustic and optical signal”, there is a receiver side microphone and a camera, too. By means of such equipment one can detect the approaching vehicle with warning device, then they inform the driver of the vehicle carrying the receiver unit on the direction and speed of the former one. The examples listed above are definitely more efficient than any traditional or human detection form, however, further developments are required. Our purpose is to find and implement such possibilities.

### BRIEF DESCRIPTION OF THE DRAWING

Presentation of the sample of utilisation is assisted by the following FIGURE:

FIG. 1—Block diagram of the system operation

### DESCRIPTION OF THE PREFERRED EMBODIMENTS

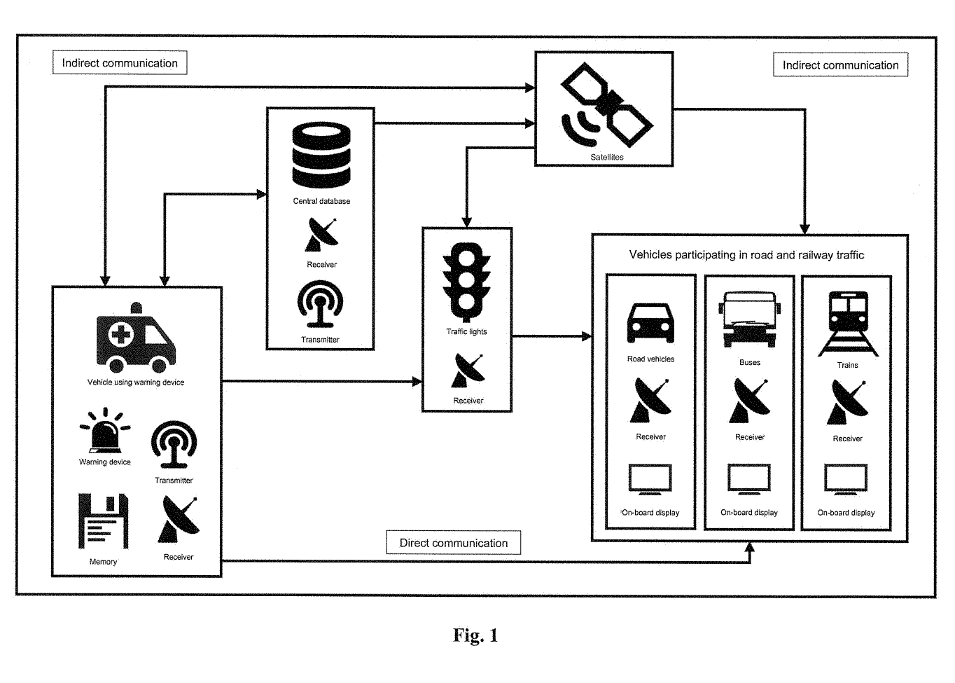

In the manner presented in FIG. 1, communication may occur through two different peripheries. The first one, and at the same time simpler structure, in which the vehicle using warning device directly sends data to the board receiver unit of the user. The second one is a communication circuit achieved through satellite connection. In this case, a central data base carries out data arrangement and their transmission to relevant suitable sites.

The solution is partly based on the fact that GPS receivers in general usage enable the determination of any vehicle with satisfactory accuracy. In the knowledge of such information, the range of transceiver of radio frequency waves can be varied and, in addition, any transceiver unit can be completed with a receiver unit, as well, due to which the vehicles using warning devices can detect their mutual closeness. There is a possibility to install such receiver units in traffic lights, in which case these lights automatically change over to prohibition phase and can accelerate the passing through of protected vehicles. By completing them with a memory, transceiver units can save the data collected on the road sections performed with warning devices, by which one can restrict the frequency of incompetent usage of marks. Provided that it is not confidential, the memory unit can comprise the target and the probable route of the vehicle with warning device, and in addition to actual direction, navigation equipment of other traffic participants can provide a more accurate image on the obstacles expected, and the participants in traffic can better plan their own route.

The invention is an arrangement signalling any vehicles using warning devices or other dangerous vehicles or objects. On the one hand, it may comprise a priority device secured to a vehicle using warning device or to other dangerous vehicles or objects, and on the other hand, several common units fastened to movable or standing objects. This priority device comprises an RF transmitter and either a switch, or it is connected to the visual or audible warning device of the vehicle. Each of the common devices contains an RF receiver module. Priority devices communicate with common devices through radiofrequency. Priority devices have a global location determination unit, a controller and a receiver module connected to them. The common devices have a control unit, graphical display and loudspeaker connected to them.

In an advantageous form of this arrangement, transceiver units and receiver units operate according to a radiofrequency standard.

Another advantageous form of the arrangement is that the common device is connected to a control unit of a transport junction.

A further version of the arrangement is that the receiver unit had been installed in the vehicle as early as in the phase of manufacture, as a sub-unit of the board computer.

But also that version is advantageous where common devices are each in connection with global positioning units.

We consider as advantageous even the arrangement where the controller of priority devices is completed with a memory unit for data registration.

In another advantageous embodiment of the arrangement, the priority device is connected to common devices by the intermediation of a base station, and receiver modules are in radiofrequency connection with at least one emitter of the base station.

Such a priority device may be installed mainly on any motor vehicle operated for public purposes, such as ambulance, fire fighters, police cars and so on, but it can be applied for the marking of accident sites, in water or air transport, e.g. marking obstacles, banks and rocks, landmarks hardly to be perceived. In the railway transport they are excellent by connecting the priority devices to the safety devices of railway crossings, as warnings to closed barriers and prohibiting signs, but they can very well signal any motions on the same track and possible dangerous situations. According to their sense, common devices are to be installed on those vehicles or moving objects (promoting their general usage by compulsory legal background) which are subject to those entitled to use any warning devices. It is recommended to connect transceiver units of the priority devices directly to a radiofrequency system with standard encoding, as well as to the receiver modules of common devices and other priority devices. In such situations, it is reasonable to emit the ID, actual coordinate and speed of the protected vehicle in proportion to its speed, but in special situations even its destination, thus, the modules of any other common or priority devices located inside the range of operation can display the data received both in visual and acoustic form. According to a secondary arrangement, transceiver units of priority devices are in RF connection with the receiver modules of common devices and other priority devices through base stations (belonging to cellular network) rather than in direct connection. The transceiver of signals can be achieved even through digital systems based on mobile Internet PTT (“Push to Talk”). At regular intervals, receiver units of priority devices will transmit the coordinates received from their global location unit (GPS, Glonass etc.) towards the base station in their range of action (including speed and destination coordinates). In this case, a central unit is to decide in which cells the given signal is to be transmitted, in order to enable any common or priority devices in that region to transmit warning acoustic signals through their connected loudspeakers, on the one hand, and to present the location, route and speed of any close active priority devices on a graphical display (which will preferably show a blind map, as well). By means of the network of base stations mentioned, a sufficient number of small power transceiver units can be used. For the protection from each other of those using warning devices it is important to apply a receiver module in priority devices. Both priority and common devices may be smartphones equipped with global location units, since they are suitable for a RF connection with base stations and, in addition, they are in possession of an emitter, receiver, control and graphic display and loudspeaker. In this case, a program of operation can be downloaded and installed as application, thus, the authority level of the smartphones used as a priority device and smartphones used as a common device are different. It reasonable to connect the priority devices to the audible or warning devices so that the RF signal is strictly related to siren sound, but in case of any other danger sources it is reasonable to use a power switch (that can be on the touch screen). Common devices may be operated even without any positioning unit, but only having an integrated passive map showing the location and other necessary data of the priority devices and not showing the position of the common device. This arrangement needs a higher attention from the user, since it is him who should calculate on the basis of map and his own place knowledge, what his position with respect to the vehicle using warning device is. When common devices have a global positioning unit, the operation is similar, but knowing position of the device the map can be more informative, the direction and distance of the vehicle using warning device can be displayed. Common devices may be peripheries of full automatic operation for the controller of each individual transport junction, giving a red sign on each route at the arrival of a protected vehicle touching the same junction, thus, accelerating its passage and preventing accident dangerous situations. In a similar manner, a priority device may be installed on any accident site or other danger sources, e.g. railway crossing. Depending upon the actual situation, this signal may be continuous (accident site, bank) but also transitional in function of an external status (e.g. barrier, closed position of light barrier). In an ideal situation, the memory of the priority device will delimit the periods performed by warning device and the route of reason. In case of railway trains, it is reasonable to adopt blind maps to railway network, and besides transmitted coordinates to specify in the transceiver, on which track a given train actually runs, since there are parallel tracks, as well. System security is largely influenced by the protection level of the signals transmitted during communication. For an expert familiar with the domain, various technologies are available for making the RF transmission safe. In addition, it is worth preparing a program structure assuring a trouble free and correct operation of the data transmission.

Especially in case of an implementation combined with smartphone, the arrangement suggested requires just a minimum of technical investment, and is able to emit complementary warning of proper quality satisfying the requirements of our days from a vehicle using warning device and approaching to us, or from any other standing or transitional danger source.

1-6. (canceled)

7. Arrangement signaling a vehicle using warning devices or any other dangerous vehicle or object, comprising a priority device secured to an emergency vehicle or any other dangerous vehicle or object and a plurality of common units secured to several moving or standing objects, the priority device comprising an RF transceiver and a switch, or alternately, the priority device is connected to the visual or audible warning device of the vehicle, each common device having an RF receiver, the priority devices being in RF connection with the common devices, the priority device being in connection with a global positioning unit, a controller and a receiver, each common device being in connection with a controller, a graphical display and a speaker, wherein both priority devices and control devices are smartphones with a downloadable application installed and equipped with global positioning units, and the authority level of the smartphones used as a priority device and smartphones used as a common device are different.
